(19) United States
(12) Patent Application Publication
(10) Pub. No.: US 2014/0283360 A1
(43) Pub. Date: Sep. 25, 2014

(54) BATTERY HOLDER AND MANUFACTURING METHOD OF BATTERY HOLDER

(71) Applicant: TOYODA GOSEI CO., LTD., Kiyosu-shi (JP)

(72) Inventors: Shinichi TAKEDA, Kiyosu-shi (JP); Jin KASUYA, Kiyosu-shi (JP); Yoshiaki KAMEDA, Kiyosu-shi (JP); Kosuke KUSABA, Kiyosu-shi (JP); Masanori KODERA, Toyota-shi (JP); Yukihiro ISOGAI, Toyota-shi (JP); Kazuhiro NORO, Toyota-shi (JP); Nobuyoshi FUJIWARA, Toyota-shi (JP)

(73) Assignee: TOYODA GOSEI CO., LTD., Kiyosu-shi (JP)

(21) Appl. No.: 14/208,126

(22) Filed: Mar. 13, 2014

(30) Foreign Application Priority Data
Mar. 21, 2013 (JP) 2013-57500

(51) Int. Cl. H01M 2/10

(52) U.S. Cl. CPC H01M 2/1022; H01M 2/1077
USPC 29/515; 429/100

(57) ABSTRACT

A battery holder holds a plurality of batteries by a simple structure. A battery holder 20 has a holder member 40 to hold batteries Bt. The holder member 40 includes a holder body 42 provided as a plate-like member, and holding holes 40S. The holding hole 40S is formed, such that a holding space 40Sa is secured between the inner wall of the holding hole 40S and the side face of the battery Bt. The holder member 40 has pressing projections 42a, each being formed by pressing and plastically deforming part of the holder body 42 toward an axial direction of the battery and formed by protruding part of the inner wall of the holding hole 40S toward the center of the battery. The pressing projections are arranged, such as to press the side face of the battery Bt and hold the battery Bt in the holder member 40.

### TECHNICAL FIELD

The invention relates to a battery holder and a manufacturing method of a battery holder.

### BACKGROUND ART

A known structure of a battery holder provided to hold a plurality of batteries fills a potting resin between the batteries for modularization. Another known structure attaches an elastically-deformable member made of an elastic material to a frame body to hold the end of each battery by the elastically-deformable member.

### DISCLOSURE OF THE INVENTION

The structure of the battery holder in which the potting resin is filled between the batteries, however, has the problem that the operation of filling the resin between the batteries is troublesome and reduces the productivity. In the structure of the battery holder in which the end of each battery is held by the elastically-deformable member, on the other hand, a variation in dimensions of batteries and dimensions of the elastically-deforming member affect other elastically-deforming members via the batteries. This may cause part of the batteries to be deformed under application of a large force or to be held by an insufficient holding force.

In order to address at least part of the problems described above, the invention may be implemented by the following aspect.

According to one aspect of the invention, there is provided a battery holder comprising a holder member configured to hold a plurality of batteries. The holder member has: a holder body provided as a plate-like member made of a plastically-deformable material, the holder body having a plurality of holding holes for receiving and holding the plurality of batteries, wherein each of the plurality of holding holes is formed such that a holding space is secured between an inner wall of the holding hole and a side face of the received battery, the holder member has a pressing projection which is formed by pressing and plastically deforming part of the holder body toward an axial direction of the received battery by an external force and which is formed by protruding part of the inner wall of the holding hole toward center of the received battery, and the pressing projection is arranged such as to press the side face of the received battery and hold the received battery in the holder member.

### BRIEF DESCRIPTION OF DRAWINGS

FIG. 1 is a perspective view illustrating a battery device in which batteries are held by a battery holder, according to one embodiment of the invention;

FIG. 2 is a plan view of the battery device of Fig. E

FIG. 3 is an enlarged perspective view showing periphery of one battery held by the battery holder of FIG. 1;

FIG. 4 is an enlarged plan view showing periphery of one battery held by the battery holder of FIG. 2;

FIG. 5 is a cross sectional view, taken on line 5-5 in FIG. 4;

FIG. 6 is a diagram illustrating a process of holding the batteries in the battery holder;

FIG. 7 is a top view illustrating a state that the batteries are set in the battery holder;

FIG. 8 is a diagram illustrating an operation subsequent to FIG. 6;

FIG. 9 is a diagram illustrating a holding mechanism of the battery holder;

FIG. 10 is a diagram illustrating periphery of a pressing projection of a holder member according to another embodiment;

FIG. 11 is a diagram illustrating a battery holder according to another embodiment; and

FIG. 12 is a flowchart showing the procedure of a manufacturing method of a battery holder as another aspect.

### BEST MODE FOR CARRYING OUT THE INVENTION

### (1) General Structure of Battery Device

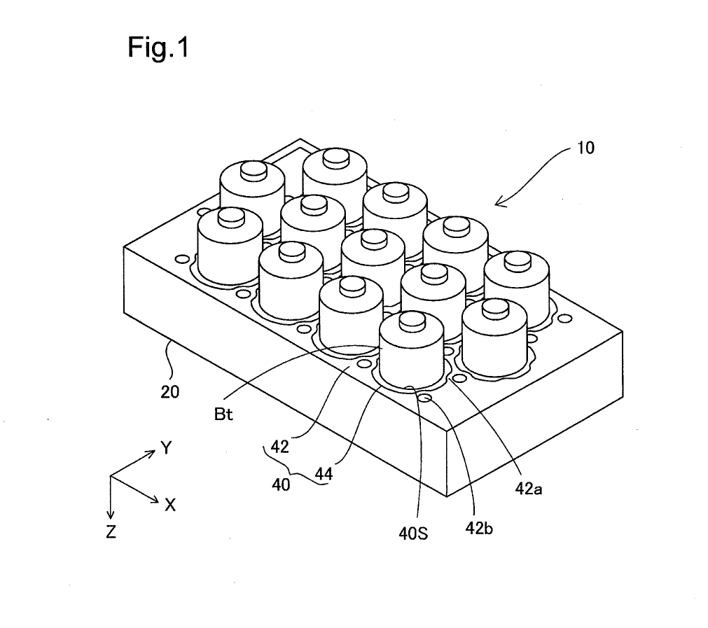

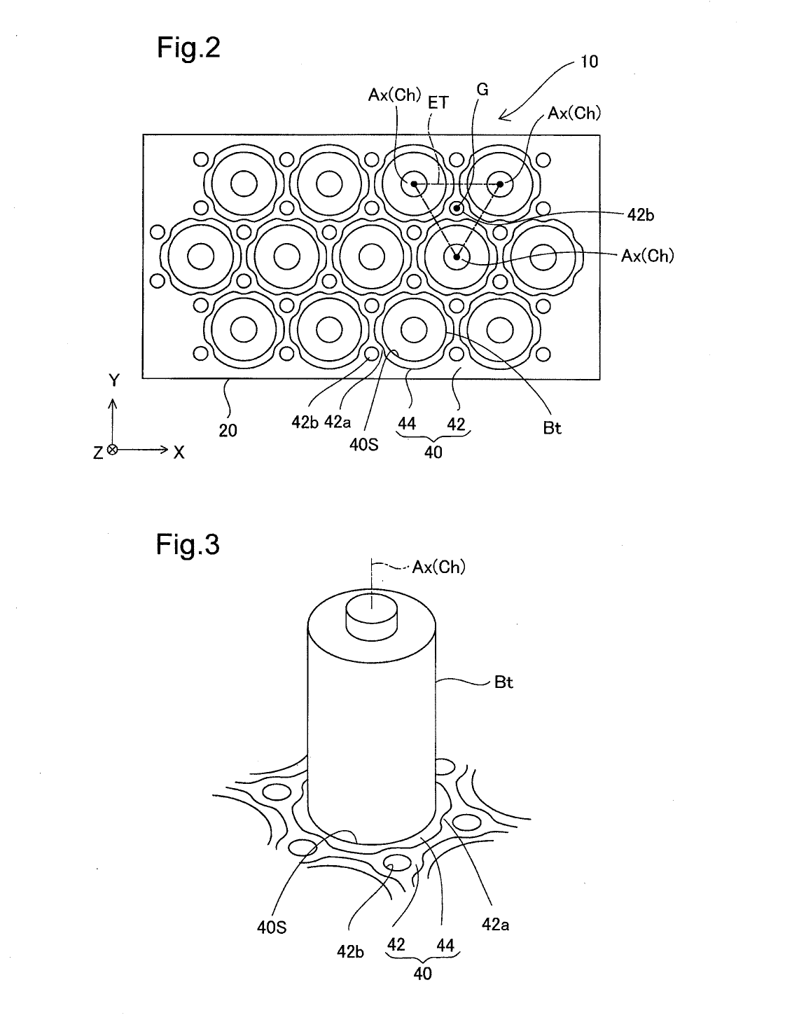

FIG. 1 is a perspective view illustrating a battery device 10 in which batteries Bt are held by a battery holder 20, according to one embodiment of the invention. FIG. 2 is a plan view of the battery device 10 of FIG. 1. The battery device 10 has a mechanism of holding a plurality of batteries Bt by the battery holder 20. The batteries are cylindrical general-purpose batteries and may be, for example, lithium ion batteries used as the power source for automobile.

The battery holder 20 has a holder member 40 to hold the plurality of batteries Bt. XYZ axes orthogonal to one another are also illustrated in FIG. 1. The Z-axis direction herein is also called the battery axial direction. The following describes the structure of the respective components.

The holder member 40 includes a holder body 42 as a plate-like member. The holder body 42 is made of a metal material, such as aluminum, which has excellent thermal conductivity and is elastically deformable by an external force. The holder body 42 has a plurality of holding holes 40S, in which a plurality of batteries are inserted and held. The plurality of holding holes 40S are in a close packing arrangement. More specifically, the lines connecting the respective centers Ch of any three adjacent holding holes 40S form an equilateral triangle ET.

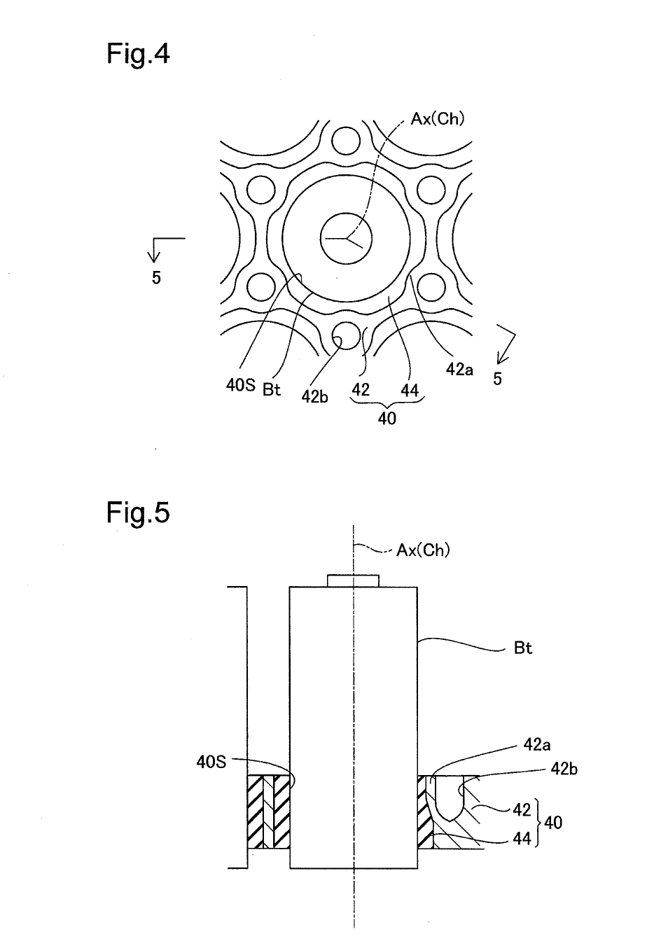

FIG. 3 is an enlarged perspective view showing periphery of one battery held by the battery holder 20 of FIG. 1. FIG. 4 is an enlarged plan view showing periphery of one battery held by the battery holder 20 of FIG. 2. The holding hole 40S has a substantially circular cross section on the plane parallel to the upper face of the holder body 42, and six pressing projections 42a are protruded toward the center direction of the holding hole 40S at intervals of 60 degrees along the circumferential direction. An elastic member 44 is attached along the entire circumference of the inner wall of the holding hole 40S. The elastic member 44 is made of an elastic material such as rubber and comes into contact with the side face of the battery Bt at the positions of the pressing projections 42a to press and hold the battery Bt.

FIG. 5 is a cross sectional view, taken on a line 5-5 in FIG. 4. A plurality of plastically-deformed recesses 42b are formed on the surface of the holder body 42. Each of the plastically-deformed recesses 42b is located at the center G of the equilateral triangle ET formed by the three centers Ax of the three adjacent batteries Bt (FIG. 2). In case where the batteries Bt are placed in the holding hole 40S properly, the centers Ax of the batteries Bt conform to the centers Ch of holding holes 40S. The plastically-deformed recesses 42b are formed by pressing part of the surface of the holder body 42 toward the axial direction of the battery Bt by an external force and plastically deforming part of the holder body 42. The flow of the plastically-deformed material of the holder body 42 runs toward the inner wall of the holding hole 40S to form the pressing projections 42a protruded toward the center Ax of the battery Bt.

### (2) Assembly Operation of Battery Holder 20

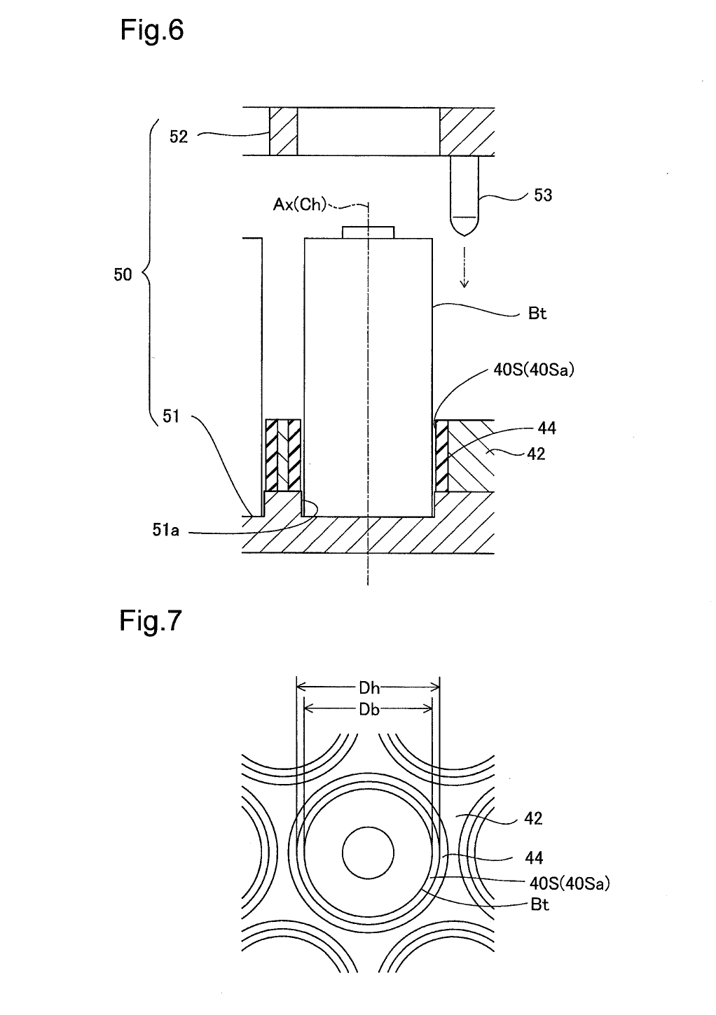

The following describes a process of setting the batteries Bt in the battery holder 20 to be integrated. FIG. 6 is a diagram illustrating a process of holding the batteries Bt in the battery holder 20. This process employs press-forming technique using a press machine 50. The press machine 50 includes a jig 51 and a press structure 52 movable up and down in the axial direction (vertical direction in the illustration). The press structure 52 has pressing projections 53 on its lower face. The process first sets each battery Bt in a recess 51a of the jig 51. The process subsequently sets the pre-provided holder body 42 over the jig 51. FIG. 7 is a top view illustrating a state that the batteries Bt are set in the battery holder 20. The holder body 42 has circular holding holes 40S prior to forming, and the elastic members 44 are mounted on the inner circumferences of the respective holding holes 40S. The holder body 42 is set on the jig 51, such that the batteries Bt are inserted into the holding holes 40S. An inner diameter Dh of the holding hole 40S is larger than an outer diameter Db of the battery Bt, and a holding space 40 Sa is secured between the holding hole 40S and the side face of the battery Bt.

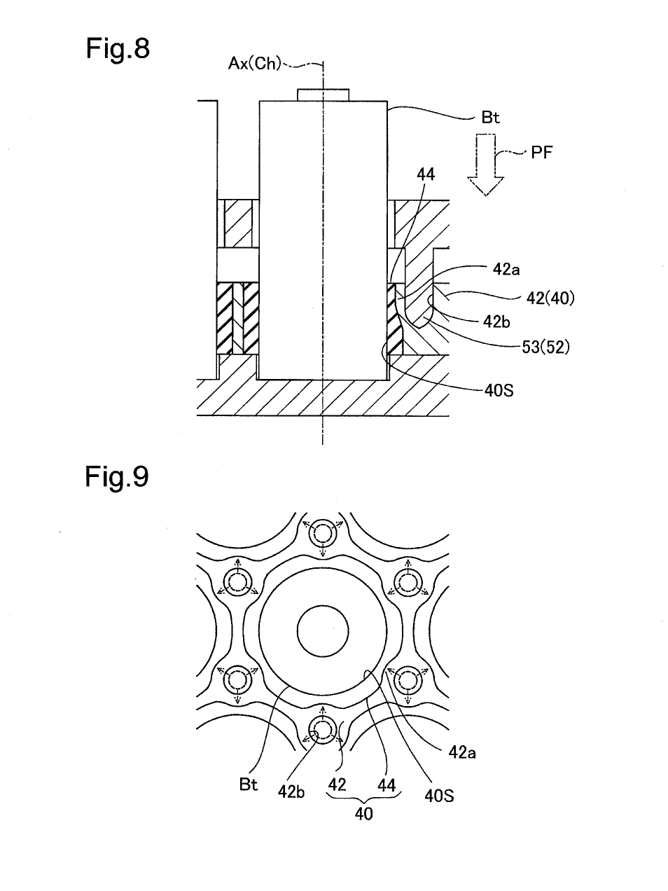

As shown in FIG. 8, the process subsequently moves down the press structure 52 to the holder body 42 and causes the pressing projections 53 to press the surface of the holder body 42 by an external force PF and plastically deform part of the upper face of the holder body 42, so as to form the plastically-deformed recesses 42b. As shown in FIG. 9, the flow of the material of the holder body 42 by press-forming narrows the holding space 40Sa (FIGS. 6 and 7) to protrude and form the pressing projections 42a. The pressing projections 42a accordingly press the side face of the battery Bt via the elastic member 44, so that the battery Bt is held in the battery holder 20. The elastic member 44 is elastically deformed to entirely fill the holding space 40Sa (FIG. 6).

### (3) Functions and Advantageous Effects of Battery Holder 20

(3)-1. As shown in FIGS. 6 to 9, after the batteries Bt are set in the jig 51 of the press machine 50, the holder body 42 is plastically deformed by pressing, so that the plurality of pressing projections 42a are formed. The pressing projections 42a press the side face of the battery Bt, so that the plurality of batteries Bt are simultaneously held by the battery holder 20. This ensures the excellent productivity.

(3)-2. As shown in FIGS. 6 and 7, when inserting the batteries Bt into the holding holes 40S of the holder body 42, the holding spaces 40Sa are secured between the inner walls of the holding holes 40S and the side faces of the batteries Bt. Accordingly, the batteries Bt are readily inserted and set in the holding holes 40S without frictional force generated between the inner wall of the holding hole 40S and the side face of the battery Bt.

(3)-3. In the press-forming process, the size of the pressing projection 42a is adjustable by regulating the size of the plastically-deformed recess 42b, i.e., the amount of plastic deformation of the holder body 42. This enables the holding force of the battery Bt by the pressing projections 42a to be readily adjusted.

(3)-4. The material of the holder body 42 is aluminum, which is readily plastically deformed by press-forming and thus facilitates the press-forming process, compared with iron-based material. The holder body 42 made of aluminum has high thermal conductivity and enables heat generated by the battery Bt to be released immediately.

(3)-5. As shown in FIG. 4, the elastic member 44 is elastically deformed when the pressing projections 42a are pressed against the side face of the battery Bt. The elastic member 44 accordingly protects the side face of the battery Bt from being damaged.

(3)-6. As shown in FIGS. 2 and 9, the plastically-deformed recess 42b of the holder body 42 is formed at the center G of the equilateral triangle ET formed by connecting the respective centers Ax of the three adjacent batteries. This arrangement enables the pressing projections 42a to be formed simultaneously at the three locations in the three holding holes 40S toward the centers Ax of the batteries. This accordingly ensures the excellent productivity.

### (4) Other Embodiments

The present invention is not limited to the embodiment described above but may be implemented by various other aspects within the scope of the invention. The following describes some of possible modifications.

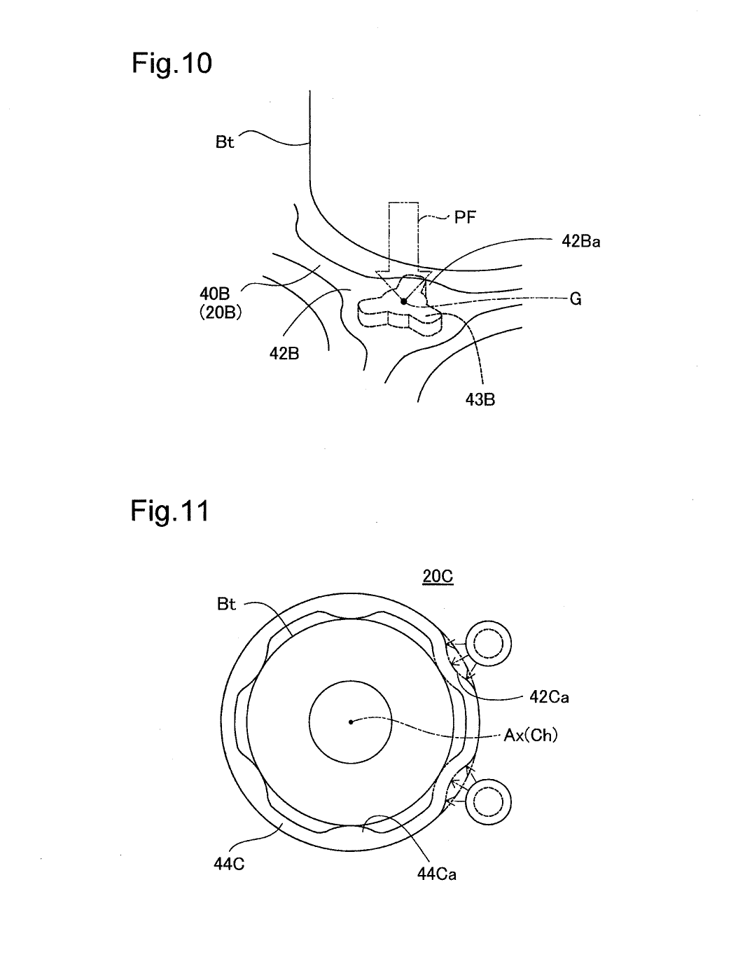

(4)-1. FIG. 10 is a diagram illustrating periphery of a pressing projection 42Ba of a holder member 40B according to another embodiment. This embodiment is characterized at the portions where a holder body 42B is plastically deformed. The holder body 42B has plastically-deformable projections 43B protruding to the direction perpendicular to the surface of the holder body 42B at the center G of the equilateral triangle ET formed by the three centers Ch of the three adjacent holding holes 40S on the surface prior to plastic deformation. The plastically-deformable projections 43B are protruded toward the three centers Ch of the three adjacent holding holes 40S at the intervals of 120 degrees about the center. In order to hold a battery Bt in a battery holder 20B, the plastically-deformable projections 43B are crushed in the axial direction by press-forming such that the projections 43B are pressed into the holder body 42 to form pressing projections 42Ba. Any of various techniques may be employed to plastically deform part of the holder body 42B and protrude and form the pressing projections 42Ba, instead of the plastically⁻deformed recesses like the embodiment shown in FIG. 1. The plastically-deformable projection 43B may be in a planar shape, as viewed along the direction perpendicular to the top surface of the holder body 42, such as to protrude in the directions to which the pressing projections 42Ba are to be formed to readily form the pressing projection 42Ba.

(4)-2. FIG. 11 is a diagram illustrating a battery holder 20C according to another embodiment. In this embodiment, the structure for holding the battery Bt includes pressing projections 42Ca provided at two positions along the circumferential direction and formed by plastic deformation with an external force by pressing, and support projections 44Ca pre-formed in an elastic member 44C. The number and the shape of the pressing projections may be set adequately to ensure the holding force of the battery.

(4)-3. The above embodiment describes the configuration that the plurality of batteries are placed in the equilateral triangular arrangement. This is, however, not restrictive, and the plurality of batteries may be placed in any of various arrangements, such as in a lattice-like arrangement or in an arrangement that minimizes the interval between the batteries for the purpose of space-saving.

(4)-4. The battery described in the above embodiment is in a cylindrical shape. This is, however, not restrictive, and the invention may be applied to other batteries, such as rectangular batteries and button batteries, in such a range that does not damage the functions and the advantageous effects of the invention.

(4)-5. The present invention may be implemented by the following aspects.

According to one aspect of the invention, there is provided a battery holder comprising a holder member configured to hold a plurality of batteries. The holder member has: a holder body provided as a plate-like member made of a plastically-deformable material, the holder body having a plurality of holding holes for receiving and holding the plurality of batteries, wherein each of the plurality of holding holes is formed such that a holding space is secured between an inner wall of the holding hole and a side face of the received battery, the holder member has a pressing projection which is formed by pressing and plastically deforming part of the holder body toward an axial direction of the received battery by an external force and which is formed by protruding part of the inner wall of the holding hole toward center of the received battery, and the pressing projection is arranged such as to press the side face of the received battery and hold the received battery in the holder member.

In the battery holder of the above aspect, after the battery is into the holding hole of the battery holder, the holder body is plastically deformed to form a plurality of the pressing projections and press the inserted battery. This enables a plurality of batteries to be simultaneously held by the battery holder. This ensures the excellent productivity.

The holding space is secured between the inner wall of the holding hole and the side face of the inserted battery, so that the batteries are readily inserted and set in the holding holes of the holder body without frictional force generated between the inner wall of the holding hole and the side face of the battery.

In elastic deformation, the size of the pressing projection is adjustable by regulating the amount of plastic deformation of the holder body. This enables the holding force of the battery by the pressing projections to be readily adjusted.

According to another aspect, there is provided the battery holder, in which the plastically deformed part of the holder body forms an elastically-deformed recess.

According to another aspect, there is provided the battery holder, in which the pressing projection has an elastic member at a location that is in contact with the side face of the received battery.

According to another aspect, there is provided the battery holder, in which the plastically-deformable material is a metal material.

According to another aspect, there is provided the battery holder, in which three adjacent holding holes in the plurality of holding holes are arranged to form a triangle, and the plastically-deformed part of the holder member is located at center of the triangle.

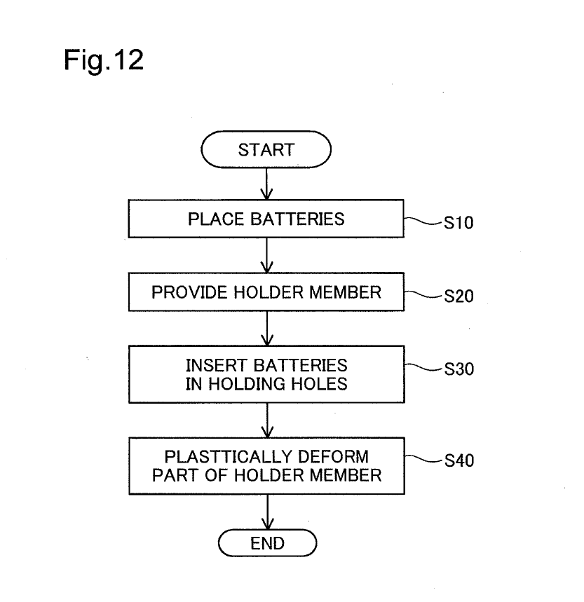

FIG. 12 is a flowchart showing the procedure of a manufacturing method of a battery holder as another aspect. According to another aspect, there is provided a manufacturing method of a battery holder, which is configured to hold a plurality of batteries. The manufacturing method comprises: placing a plurality of batteries (S10); providing a holder member which is made of a plastically-deformable material and has a plurality of holding holes formed corresponding to the plurality of placed batteries, wherein each of the plurality of holding holes is formed such that a holding space is secured between an inner wall of the holding hole and a side face of the corresponding battery when the corresponding battery is inserted in the holding hole (S20); inserting each of the plurality of batteries in the corresponding holding hole(S30); and plastically deforming part of the holder member by an external force (S40), so as to protrude and form a pressing projection from the wall face of the holding hole toward the battery and press the side face of the battery, so as to hold the plurality of batteries in the holder member.

1. A battery holder, comprising a holder member configured to hold a plurality of batteries, wherein
the holder member comprises a holder body provided as a plate⁻like member made of a plastically-deformable material, the holder body having a plurality of holding holes for receiving and holding the plurality of batteries, wherein
each of the plurality of holding holes is formed such that a holding space is secured between an inner wall of the holding hole and a side face of the received battery,
the holder member has a pressing projection which is formed by pressing and plastically deforming part of the holder body toward an axial direction of the received battery by an external force and which is formed by protruding part of the inner wall of the holding hole toward center of the received battery, and
the pressing projection is arranged such as to press the side face of the received battery and hold the received battery in the holder member.

2. The battery holder according to claim 1, wherein
the plastically deformed part of the holder body forms an elastically-deformed recess.

3. The battery holder according to claims 1, wherein
the pressing projection has an elastic member at a location that is in contact with the side face of the received battery.

4. The battery holder according to claim 1, wherein
the plastically-deformable material is a metal material.

5. The battery holder according to claim 1, wherein
three adjacent holding holes in the plurality of holding holes are arranged to form a triangle, and
the plastically-deformed part of the holder member is located at center of the triangle.

6. A manufacturing method of a battery holder which is configured to hold a plurality of batteries, the manufacturing method comprising:
placing a plurality of batteries;
providing a holder member which is made of a plastically-deformable material and has a plurality of holding holes formed corresponding to the plurality of placed batteries, wherein each of the plurality of holding holes is formed such that a holding space is secured between an inner wall of the holding hole and a side face of the corresponding battery when the corresponding battery is inserted in the holding hole;
inserting each of the plurality of batteries in the corresponding holding hole; and
plastically deforming part of the holder member by an external force, so as to protrude and form a pressing projection from the wall face of the holding hole toward the battery and press the side face of the battery, so as to hold the plurality of batteries in the holder member.
